(19) United States
(12) Patent Application Publication
(10) Pub. No.: US 2012/0075236 A1
(43) Pub. Date: Mar. 29, 2012

(54) TERMINAL WITH TOUCH SCREEN

(75) Inventors: Woon Chun Kim, Gyunggi-do (KR); Yong Soo Oh, Gyunggi-do (KR); Hyun Jun Kim, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 13/024,188

(22) Filed: Feb. 9, 2011

(30) Foreign Application Priority Data
Sep. 29, 2010 (KR) 1020100094519

(51) Int. Cl. G06F 3/045; G06F 3/041

(52) U.S. Cl. 345/174; 345/173

(57) ABSTRACT

Disclosed herein is a terminal with a touch screen, including: a main body part including a display and a first touch screen positioned on the display; a folder part including a second touch screen, and transparent dots protruding from the second touch screen; a hinge part connecting one side of the folder part to the main body part so that the folder part is in a closed state or an open state with respect to the main body part; and a controller selectively operating the first touch screen and the second touch screen, whereby the transparent dots are provided on the second touch screen, thereby making it possible to improve operating feeling to at the time of touching the terminal and accomplishing accurate touch.

### CROSS REFERENCE TO RELATED APPLICATION

This application claims the benefit of Korean Patent Application No. 10-2010-0094519, filed on Sep. 29, 2010, entitled “Terminal With Touch Screen” which is hereby incorporated by reference in its entirety into this application.

### BACKGROUND OF THE INVENTION

1. Technical Field

The present invention relates to a terminal with a touch screen.

2. Description of the Related Art

With the continuous development in the electronic technology and the information technology fields, the relative importance of electronic devices is constantly increasing in everyday life, including work environment. In particular, as electronic technology continuously develops, personal computers and portable transmitters etc. process texts and graphics, using a variety of input devices, such as a keyboard, a mouse, a digitizer, etc. These input devices, however, have been developed in consideration of the expanding usage of personal computers, such that they are difficult to be applied to portable devices that have been recently reduced in size and thickness. Therefore, touch screens are on the rise as an input device appropriate for the portable devices.

Touch screens, devices generally installed in display devices to detect positions on the screen touched by a user and control electronic devices, use information on the detected contact position as input information, in addition to controlling the screen of the display, have various advantages of being simply operated with minimal malfunction in a small space and very compatible with IT devices.

Meanwhile, the touch screen is classifiable as a resistive type, a capacitive type, an electromagnetic type, a surface acoustic wave (SAW) type, an infrared type, and so on. Among others, resistive and capacitive types are prevalently used in consideration of the functional and economical aspects.

In the case of a terminal having a touch screen recently released, a bar-type integrated terminal with a touch screen installed on a top surface of a display and surrounded by a frame is mainly used. The integrated terminal has a single-layer shape in which a folder part, a slide part, or a flip part is not separately provided. A user may apply a touch input to a touch screen using such a terminal, while viewing images displayed on a display, and the touch screen may sense a position of the touch input to represent an operation corresponding thereto on the display.

However, in the case of a terminal with a touch screen according to the prior art, it has been difficult to touch a number type or character type keyboard. More specifically, when a number type keyboard or a QWERTY type keyboard is displayed on a display meeting the recent trends for miniaturization, a size of an area on which each number or character will be touched is small, such that it has been very difficult to distinguish and touch them.

### SUMMARY OF THE INVENTION

The present invention has been made in an effort to provide a terminal with a touch screen capable of distinguishing and accurately touching each number or character when a number type, a QWERTY type display, or the like is displayed on a display.

A terminal with a touch screen according to a preferred embodiment of the present invention includes: a main body part including a display and a first touch screen positioned on the display; a folder part including a second touch screen, and transparent dots protruding from the second touch screen; a hinge part connecting one side of the folder part to the main body part so that the folder part is in a closed state or an open state with respect to the main body part; and a controller selectively operating the first touch screen and the second touch screen.

When the folder part is in an open state with respect to the main body part, the controller may operate the first touch screen, and when the folder part is in a closed state with respect to the main body part, the controller may operate the second touch screen.

The transparent dots may protrude from a surface opposite to a surface where the folder part meets the main body part.

The first touch screen may be a capacitive touch screen.

The second touch screen may be a resistive or capacitive touch screen.

The main body part may include a transmitting part and the folder part may include a receiving part.

The transparent dot may be formed of a convex lens.

The terminal with a touch screen may further include a sensing part sensing a closed state or an open state of the folder part.

### BRIEF DESCRIPTION OF THE DRAWINGS

FIG. 1 is a perspective view showing an open state of a terminal with a touch screen according to a preferred embodiment of the present invention;

FIG. 2 is a perspective view showing a closed state of the terminal with a touch screen shown in FIG. 1;

FIG. 3 is a cross-sectional view of a main body part included in the terminal with a touch screen shown in FIG. 1; and

FIG. 4 is a control block diagram of the terminal with a touch screen shown in FIG. 1.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, terms used in the specification, ‘first’, ‘second’, etc., can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments according to the present invention will be described in detail with reference to the accompanying drawings.

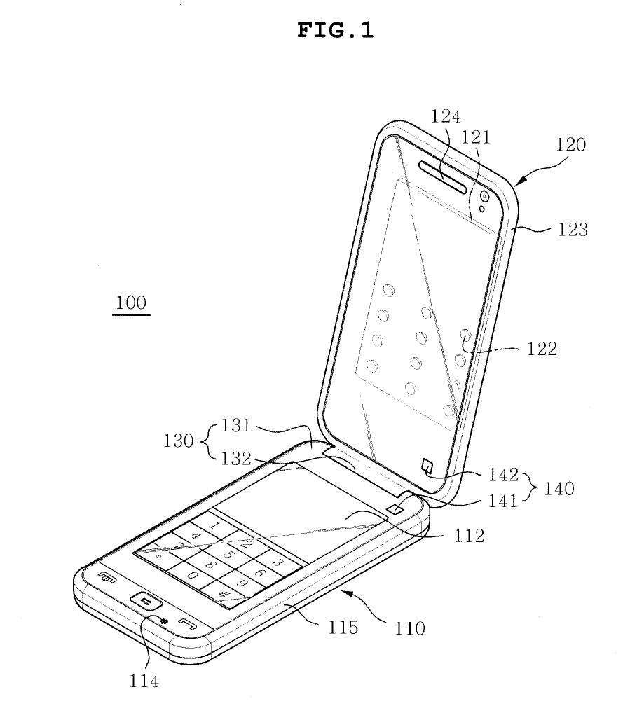

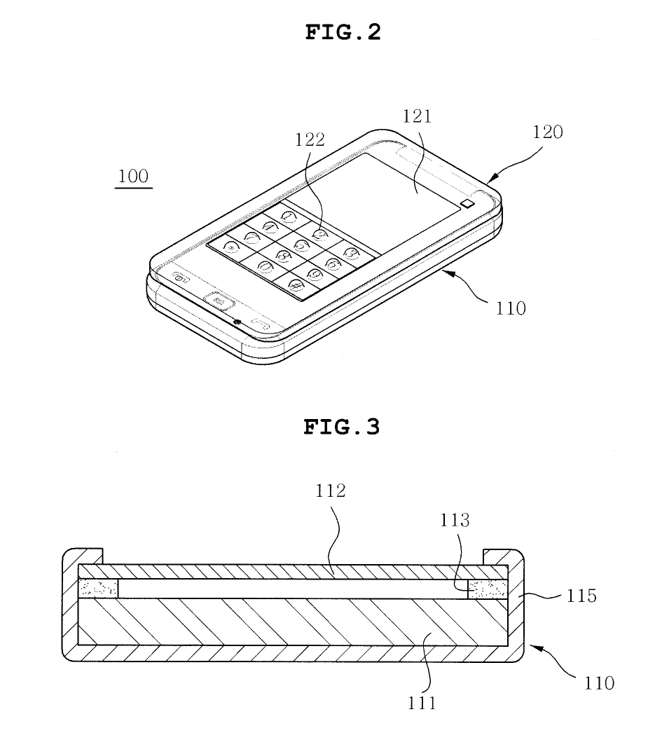

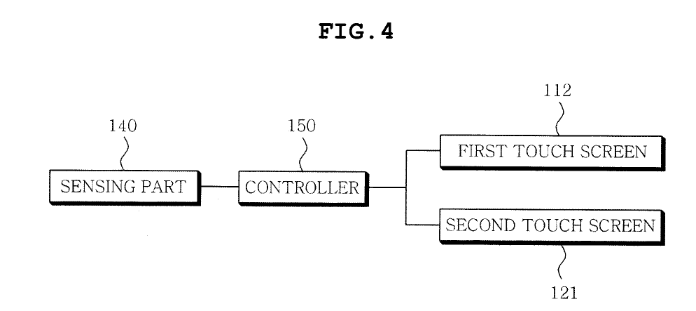

FIG. 1 is a perspective view showing an open state of a terminal 100 with a touch screen according to a preferred embodiment of the present invention, FIG. 2 is a perspective view showing a closed state of the terminal 100 with a touch screen shown in FIG. 1, FIG. 3 is a cross-sectional view of a main body part 110 included in the terminal 100 with a touch screen shown in FIG. 1, and FIG. 4 is a control block diagram of the terminal 100 with a touch screen shown in FIG. 1. Hereinafter, the terminal 100 with a touch screen according to the present embodiment will be described with reference to these figures.

In this configuration, it will be noted beforehand that a “closed state” of a folder part 120 with respect to the main body part 110 implies that the folder part 120 is folded to be in contact with the main body part 110, and an “open state” of the folder part 120 with respect to the main body part 110 implies that the folder part 120 is unfolded to be spaced apart from the main body part 110, except for a hinge part 130.

As shown in FIGS. 1 to 4, the terminal 100 with a touch screen according to the present embodiment includes the main body part 110 including a display 111 and a first touch screen 112, the folder part 120 including a second touch screen 121 and a transparent dot 122, the hinge part 130 connecting the main body part 110 to the folder part 120, a sensing part 140 sensing a closed state or an open state, and a controller 150 selectively operating the first touch screen 112 and the second touch screen 121.

The main body part 110 may include the display 111 and the first touch screen 112.

Herein, the display 111 is a unit showing images for transferring information to a user and showing feedback to the user, the feedback generated when the first touch screen 112 or the second touch screen 121 is touched by the user. As the display 111, for example, a liquid crystal display (LCD), a plasma display panel (PDP), an electroluminescence (EL), a cathode ray tube (CRT) or the like may be used.

As an example, when the display 111 is configured of the thin film transistor (TFT) liquid crystal display, the display 111 may be configured to include a lower plate on which a thin film transistor and a pixel electrode are arranged, an upper plate including a color filter representing colors and a common electrode, and liquid crystals filled between the upper plate and the lower plate. In addition, polarizing plates linearly polarizing a visible ray (natural light) may each be attached onto the upper plate and the lower plate.

The first touch screen 112, which is a member bonded onto the display 111 in the main body part 110, is a unit receiving a user's input.

In this configuration, the first touch screen 112, which is an input unit operating when the folder part 120 is in an open state, may be a capacitive touch screen by way of example. At this time, the first touch screen 112 may include a transparent substrate, a transparent electrode formed on the transparent substrate, and a window plate bonded onto the transparent substrate. When a touch input is executed, the transparent electrode becomes an electrode and the transparent substrate, the window plate or the like becomes a dielectric, such that the transparent electrode may sense a change in capacitance and a controller 150 receiving signals therefor may sense a position of the touch input.

Meanwhile, as shown in FIG. 3, the first touch screen 112 may be bonded to the display 111 by an adhesive layer 113, wherein the adhesive layer 113 may be a double-sided adhesive tape (DAT) or an optical clear adhesive (OCA). As shown in FIG. 3, when the adhesive layer 113 is a double-sided adhesive layer, edges of the first touch screen 112 and the display 111 may be bonded to each other, and when the adhesive layer 113 is an optical clear adhesive, the first touch screen 112 and the display 111 may be entirely bonded to each other.

Meanwhile, the main body part 110 may further include a transmitting part 114, a circuit substrate (not shown) for various control, and a first frame part 115.

Herein, the transmitting part 114 is a member receiving a user's voice. If voice signals from the transmitting part 114 are transferred to the controller 150, the controller 150 may convert the voice signals into electrical signals to transfer them to a counterpart's terminal. Therefore, as the transmitting part 114, a microphone may be used by way of example. In addition, the circuit substrate (not shown) may serve to transfer or control electrical signals generated from the transmitting part 114, the receiving part 124, the first touch screen 112, and/or the second touch screen 121.

In addition, the first frame part 115 may be formed to surround the display 111, the first touch screen 112, the circuit substrate (not shown), or the like so as to protect them. The first frame part 115 may be implemented to have a shape in which one surface of the first touch screen 112 is opened so that a user's touch input can be applied thereto. In addition, in the case of the main body part 110, it is not required to be transparent except for the first touch screen 112, such that the first frame part 115 may be formed of opaque plastic or the like.

The folder part 120 may include the second touch screen 121 and the transparent dot 122.

In this configuration, the second touch screen 121, which is a member that becomes an input unit when the folder part 120 is in a closed state with respect to the main part 110, may be a capacitive touch screen or a resistive touch screen by way of example. When the second touch screen 121 is a resistive touch screen, it may include two sheets of transparent substrates and transparent electrodes formed on each of the transparent substrates, wherein edges of the two sheets of transparent substrates may be bonded to each other by, for example, an adhesive layer such as a double-sided adhesive tape (DAT). In addition, when a touch input is executed, the transparent electrodes formed on the two sheets of transparent substrates may be in contact with each other to sense a change in resistance or voltage, and the controller 150 receiving such signals may sense a position of the touch input.

Meanwhile, the transparent dots 122 protruding to the outside may be formed on the second touch screen 121.

In this configuration, the transparent dot 122, which is a member improving operating feeling at the time of operating the second touch screen 121, may be made of a transparent material having appropriate hardness, such as acrylic resin or the like, by way of example. In addition, as shown in FIGS. 1 and 2, the transparent dots 122 may be arranged to have a number arrangement type by way of example and thus, when a number type keyboard is displayed on the display 111, the operating feeling of the second touch screen 121 may be improved and a user may accurately touch the desired numbers. In addition, the transparent dots 122 may be arranged to have a character type keyboard such as a QWERTY type keyboard or the like.

Meanwhile, the transparent dots 122 may be configured of a convex lens. When the transparent dot 122 is configured of a convex lens, the keyboard displayed on the display 111 may be exaggerated and thus, even when characters displayed on the keyboard are small, the desired characters may be accurately touched. In particular, the transparent dots may exert more remarkable effects in the recent trends for a small touch keyboard.

In addition, the transparent dot 122 may be implemented to have a hemispherical shape by way of example. When the transparent dot 122 is implemented to have a hemispherical shape, portions touched by fingers are rounded, such that operating feeling may be further improved.

Meanwhile, a protruding direction of transparent dot 122 may be a surface opposite to a surface where the folder part 120 meets the main body part 110 and thus, even in a closed state of the folder part 120 with respect to the main body part 110, the transparent dot 122 may be exposed to the outside on the second touch screen 121.

Meanwhile, the folder part 120 may further include the second frame part 123, the receiving part 124, the circuit substrate (not shown) of the main body part 110, and wirings (not shown) for transferring various electrical signals to the controller (not shown).

In this configuration, the second frame part 123, which is a member surrounding other components of the folder part 120, may expose one surface of the second touch screen 121 on which the transparent dots 122 are formed to the outside so that a user can apply a touch input to the second touch screen 121. In addition, when the folder part 120 is implemented to be entirely transparent, the second frame part 123 may be made of a transparent material, for example, polyethylene terephthalate (PET), polycarbonate (PC), polymethylemethacrylate (PMMA), or the like. In addition, when the second frame part 123 is not configured to be transparent, the second frame part 123 may be implemented to have a shape in which both surfaces of the second touch screen 121 are opened so that a user can see the display 111 of the main body part through the second touch screen 121 in a closed state.

Meanwhile, the receiving part 124 is a member outputting voice. More specifically, when the controller 150 converts the electrical signals from a counterpart's terminal into voice signals, the receiving unit 124 may transfer the counterpart's voice to a user. Therefore, as the receiving part 124, a speaker may be used by way of example. In addition, wirings (not shown) are a member transferring the electrical signals between the receiving part 124 or the second touch screen 121 and the circuit substrate (not shown) of the main body part 110. In this configuration, when the folder part 120 is configured to be transparent, the wirings (not shown) may be made of a transparent material, for example, a conductive polymer containing poly-3, 4-ethylenedioxythiophene/polystyrenesulfonate (PEDOT/PSS), polyaniline alone or a mixture thereof, or metal oxides, such as indium tin oxide (ITO).

The hinge part 130 is a member connecting the main body part 110 to the folder part 120.

In this configuration, the hinge part 130 may connect the folder part 120 rotatably to the main body part 110. More specifically, the hinge part 130 may be configured to include a first hinge part 131 formed on one side of the main body part 110 and a second hinge part 132 formed on one side of the folder part 120. As shown in FIG. 1, the folder part 120 may be connected to the main body part 110 by positioning the second hinge part 132 between the first hinge parts 131 and inserting pins into holes or the like of the inside of the hinge part 130. In addition, the folder part 120 may also be connected to the main body part 110 by positioning the first hinge part 131 between the second hinge parts 132. In addition, the hinge part 130 is not limited to the type as described but may also be implemented to be in a semi automatic type including springs or the like, an automatic type driven by electricity, or the like.

When the folder part 120 is connected to the main body part 110 by the hinge part 130, the folder part 120 may perform a relative rotation motion with respect to the main body part 110 based on the hinge part 130, while one side of the folder part 120 being connected to the main body part 110. Therefore, the folder part 120 may repeats a closed state or an open state with respect to the main body part 110.

The sensing part 140 is a unit sensing a closed state or an open state of the folder part 120.

In this configuration, the sensing part 140 may be configured of a sensor by way of example. More specifically, a first sensor 141 may be installed on the main body part 110 and a second sensor 142 may be installed on the folder part 120, wherein the folder part 120 is in a closed state, the first sensor 141 and the second sensor 142 may be mutually matched, thereby making it possible to sense the closed state of the folder part 120. However, the sensing part 140 is not limited to a sensor but may also be a unit, such as a single pole double throw (SPDT) switch or the like, capable of sensing an open state and a closed state.

Meanwhile, as shown in FIG. 4, when the sensing part 140 senses a closed state or an open state of the folder part 120, it may transfer the electrical signals therefor to the controller 150.

The controller 150 is a member controlling several electrical signals and selectively operating the first touch screen 112 and the second touch screen 121.

In this configuration, when the folder part 120 is in an open state with respect to the main body part 110, the controller 150 may operate the first touch screen 112 and when the folder part 120 is in a closed state with respect to the main body part 110, the controller 150 may operate the second touch screen 121. In addition, the controller 150 receives the electrical signals as to the opened or closed state of the folder part 120 from the sensing part 140. When the folder part 120 is in an open state, the controller 150 may transmit operation signals to the first touch screen 112 and may transmit stop signals to the second touch screen 121. When the folder part 120 is in a closed state, the controller 150 may transmit stop signals to the first touch screen 112 and may transmit operation signals to the second touch screen 121.

In this case, when using the terminal 100 with a touch screen, a user may apply a touch input to the first touch screen 112, while having the folder part 120 in an open state, at the time of using menus, icons, and the like, and may apply a touch input to the second touch screen 121 through the transparent dots 122, while having the folder part 120 in a closed state, at the time of using character type keyboard, thereby making it possible to more accurately touch the character type keyboard while facilitating operation thereof.

Meanwhile, the controller 150 may control several electrical signals as well as the selective operation of the first touch screen 112 and the second touch screen 121. As an example, the controller 150 may receive the electrical signals for a change in capacitance, voltage or resistance sensed by the transparent electrodes of the first touch screen 112 and the second touch screen 121 and serve to detect positions of the touch input. In addition, the controller 150 may convert voice input by the transmitting part 114 into the electrical signals to transmit them to a base station or the like or convert electrical signals input by a base station or the like into voice to output them to the receiving part 124. In addition, such a control may be performed by a single central processing unit or the controller 150 may be scattered to perform each control.

Meanwhile, when the folder part 120 is implemented to be transparent, it may be installed on the main body part 110 due to a difficulty in manufacturing the controller 150 to be transparent.

In the terminal with a touch screen according to the present invention, the transparent dots are formed on the second touch screen installed on the folder part, thereby making it possible to improve operating feeling at the time of touching the terminal and accurately touch a number or character type keyboard.

In addition, according to the present invention, the transparent dots are formed of a convex lens to enlarge numbers or characters displayed on the display, thereby making it possible to accomplish more accurate touch.

Although the embodiment of the present invention has been disclosed for illustrative purposes, it will be appreciated that a terminal with a touch screen according to the invention is not limited thereby, and those skilled in the art will appreciate that various modifications, additions and substitutions are possible, without departing from the scope and spirit of the invention.

Accordingly, such modifications, additions and substitutions should also be understood to fall within the scope of the present invention.

What is claimed is:

1. A terminal with a touch screen, comprising:
a main body part including a display and a first touch screen positioned on the display;
a folder part including a second touch screen, and transparent dots protruding from the second touch screen;
a hinge part connecting one side of the folder part to the main body part so that the folder part is in a closed state or an open state with respect to the main body part; and
a controller selectively operating the first touch screen and the second touch screen.

2. The terminal with a touch screen as set forth in claim 1, wherein when the folder part is in a open state with respect to the main body part, the controller operates the first touch screen, and when the folder part is in a closed state with respect to the main body part, the controller operates the second touch screen.

3. The terminal with a touch screen as set forth in claim 1, wherein the transparent dots protrude from a surface opposite to a surface where the folder part meets the main body part.

4. The terminal with a touch screen as set forth in claim 1, wherein the first touch screen is a capacitive touch screen.

5. The terminal with a touch screen as set forth in claim 1, wherein the second touch screen is a resistive or capacitive touch screen.

6. The terminal with a touch screen as set forth in claim 1, wherein the main body part includes a transmitting part and the folder part includes a receiving part.

7. The terminal with a touch screen as set forth in claim 1, wherein the transparent dot is formed of a convex lens.

8. The terminal with a touch screen as set forth in claim 1, further comprising a sensing part sensing a closed state or an open state of the folder part.
